(19) United States
(12) Patent Application Publication
(10) Pub. No.: US 2004/0221740 A1
(43) Pub. Date: Nov. 11, 2004

(54) Bread maker

(75) Inventors: Jae-ryong Park, Suwon-city (KR); Yong-hyun Kwon, Suwon-city (KR); Chul Kim, Anyang-city (KR); Tae-uk Lee, Suwon-city (KR); Han-jun Sung, Suwon-city (KR); Jang-woo Lee, Suwon-city (KR); Dong-bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 10/807,263

(22) Filed: Mar. 24, 2004

(30) Foreign Application Priority Data
May 7, 2003 (KR) 2003-29089

(51) Int. Cl. A23L 1/00

(52) U.S. Cl. 99/348

(57) ABSTRACT

A bread maker including a main body forming an oven compartment; a pair of kneading drums which are spaced apart from each other in the upper and lower parts of the oven compartment and hold opposite ends of a mixing bag, respectively; a baking tray including stationary and movable tray members which are disposed between the pair of kneading drums facing each other and forming slit to pass the mixing bag therethrough, the movable tray member being formed with combining projections on opposite sidewalls thereof; and a pair of tray holder members which supports the stationary tray member and is formed with guide grooves to accommodate the combining projections for rotatably supporting the movable tray member, being combined with opposite ends of the baking tray, wherein a screw hole communicating with the guide groove is formed at one end of each of the tray holder members and an adjusting member moving the movable tray member is connected with the screw hole, so that the width of the slit can be adjusted. Thus, the width of the slit can be kept constant, so that the materials in the mixing bag can be uniformly kneaded during the kneading process.

### CROSS-REFERENCE TO RELATED APPLICATIONS

This application claims the benefit of Korean Patent Application No. 2003-029089, filed on May 7, 2003, in the Korean Intellectual Property Office, the disclosure of which is incorporated herein by reference.

### BACKGROUND OF THE INVENTION

1. Field of the Invention

The present invention relates to a bread maker, and more particularly to a bread maker in which dough in a mixing bag can be uniformly kneaded during a kneading process.

2. Description of the Related Art

Generally, bread is made by using a bread maker which automatically performs multiple steps such as kneading, leavening and baking of raw materials for bread.

For example, the bread maker disclosed in Korean Patent Publication No. 2001-0032188 includes a housing forming an external appearance of a bread maker; a door provided in the housing; and an LCD display part provided in a front side of housing.

Upper and lower rollers are rotatably disposed in parallel in the upper and lower parts of the housing to wind opposite ends of a mixing bag. A pair of upper members are placed between the upper and lower rollers to prevent the raw materials kneaded in the mixing bag from being moved to the upper roller.

A baking tray is provided between the pair of upper members and the lower roller which can be slid out of the oven compartment and contains kneaded materials therein.

The baking tray is box-shaped having a top opening by combining a stationary part and a movable part symmetrical to each other. A slit is formed along the line where the movable part meets the stationary part and extends from a sidewall to the bottom, wherein pivot means of the movable part is combined with pivot holders.

The raw materials contained in the mixing bag are reciprocated up and down by the upper and lower rollers during a kneading process, thereby being kneaded between the pair of upper members and the baking tray. After completing the kneading process, the mixing bag is removed and dough contained in the baking tray is baked.

In a conventional bread maker, the mixing bag is reciprocated up and down through the slit of the baking tray during a kneading process. When the mixing bag moves up, the pair of upper members prevents the dough in the mixing bag from being moved up toward the upper roller. When the mixing bag moves down, the dough in the mixing bag cannot pass through the narrow slit of the baking tray, so that the dough can be repetitively kneaded. Thus, it is essential to keep the width of the slit constant in spite of repetitive usage. Hence, to obtain well-kneaded uniform dough from materials in the mixing bag, a means for adjusting the width of the slit may be required so as to keep the width of the slit constant.

### SUMMARY OF THE INVENTION

Accordingly, it is an aspect of the present invention to provide a bread maker in which dough in a mixing bag can be uniformly kneaded during the kneading process.

Additional aspects and advantages of the invention will be set forth in part in the description which follows and, in part, will be obvious from the description, or may be learned by practice of the invention.

The foregoing and/or other aspects of the present invention are achieved by providing a bread maker comprising a main body forming an oven compartment; and a pair of kneading drums which are spaced apart from each other in the upper and lower parts of the oven compartment and hold opposite ends of a mixing bag, respectively; a baking tray having stationary and movable tray members which are disposed between the pair of kneading drums facing each other and forming a slit to pass the mixing bag therethrough, the movable tray member being formed with combining projections on opposite sidewalls thereof; and a pair of tray holder members which supports the stationary tray member and is formed with a plurality of guide grooves to accommodate the combining projections for rotatably supporting the movable tray member, wherein a screw hole communicated with the plurality of guide grooves is formed at one end of each of the tray holder members and an adjusting member moving the movable tray member is connected with the screw hole, so that the width of the slit can be adjusted.

According to an aspect of the invention, each of the tray holder members is formed with a first guide groove, a second guide groove and a screw hole which is communicated with the second guide groove toward the transverse direction of the slit.

According to an aspect of the invention, the bread maker further comprises a pair of dough profile parts which is projected facing each other in the slit and contacts with the mixing bag.

According to an aspect of the invention, the adjusting member is an adjusting bolt screw-engaged with the screw hole of the tray holder member.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a baking tray assembly of a bread maker of the present invention;

FIG. 2 is a combined perspective view of the baking tray assembly of FIG. 1;

FIG. 3 is an exploded perspective view of the baking tray assembly of FIG. 2;

FIGS. 4 and 5 are sectional views illustrating how a movable tray member moves to adjust the width of the slit, taken along line IV-IV in FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

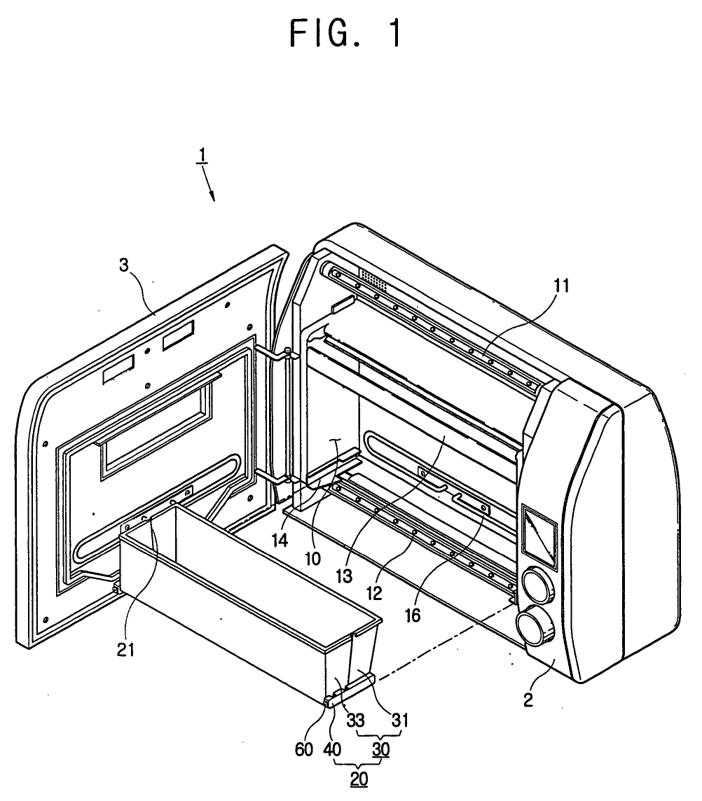

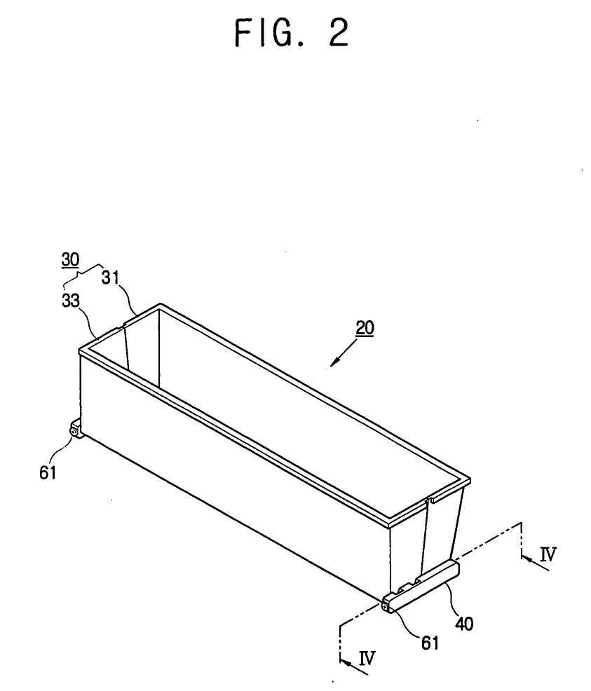

In FIGS. 1-3, a bread maker according to of the present invention comprises: a main body 1 provided with an oven compartment 10; a door 3 to rotatably open and close a front opening of the oven compartment 10; and an operation display panel to show an operation state of the main body 1.

Upper and lower kneading drums 11 and 12 rotatably disposed in the upper and lower parts of the oven compartment 10 are placed in parallel to wind opposite ends of a mixing bag (not shown) filled with raw materials for bread in clockwise and counterclockwise directions. A pair of dough-blocking members 13 are placed between the upper and lower kneading drums 11 and 12 to prevent the raw materials kneaded in the mixing bag from being moved to the upper kneading drum 11.

A baking tray assembly 20 is provided between the upper and lower kneading drums 11 and 12 in the lower part of the oven compartment 10. The baking tray assembly 20 may be slid out from the oven compartment 10 and contains kneaded materials for bread therein.

The baking tray assembly 20 comprises a baking tray 30 having stationary and movable tray members 31 and 33 respectively, both of L-shaped sections symmetrical to each other; and a pair of tray holder members 40 connected with opposite ends of the stationary and movable tray members 31 and 33, respectively.

Stationary projections 32 securely combined with the pair of tray holder members 40 are projected from the lower surface of the opposite sidewalls of the stationary tray member 31. Combining projections 34 movably combined with the pair of tray holder members 40 are projected from the lower surface of the opposite sidewalls of the movable tray member 33.

The pair of tray holder members 40 is slidingly combined with guide members 14 which are mounted on opposite inner sidewalls of the oven compartment 10. The stationary projections 32 of the stationary tray member 31 are inserted into the stationary projections accommodating parts 41 which are grooved into the tray holder member 40. The combining projections 34 of the movable tray member 33 are movably inserted into guide grooves 42 formed in the tray holder member 40.

The guide grooves 42 form a pair provided in each of the tray holder members 40 and comprise a first guide groove 42a positioned adjacent to the stationary tray member 31 and a second guide groove 42b positioned adjacent to the first guide groove 42a.

When the stationary projections 32 of the stationary tray member 31 are inserted in the stationary projections accommodating parts 41 of the tray holder member 40, the stationary tray member 31 is securely mounted on the tray holder member 40. Similarly, when the combining projections 34 of the movable tray member 33 are movably inserted in the guide grooves 42 of the tray holder member 40, the movable tray member 33 is movably mounted on the tray holder member 40.

When the stationary and movable tray members 31 and 33 are mounted on the tray holder member 40 facing each other, the baking tray 30 of a box shape having a top opening for containing the raw materials for bread is formed. A slit 21 is formed along the line where the stationary and movable tray members 31 and 33 are met. A pair of dough profile parts 50 are provided in the slit 21. The dough profile parts are projected facing each other and contacting with each other when the mixing bag is introduced between the slit 21.

The bread maker further comprises an adjusting means which adjusts the width of the slit 21 so as to keep the width constant when the mixing bag is reciprocated up and down through the slit 21.

The adjusting means comprises a screw hole 60 formed at the front end of the tray holder member 40 along the transverse direction of the slit 21 and communicated with the second guide groove 42b; and an adjusting bolt 61 as an adjusting member which is screw-engaged with the screw hole 60 and moves the movable tray member 33 toward the transverse direction of the slit 21, so that the width of the slit 21 can be adjusted.

When the adjusting bolt 61 screw-engaged with the screw hole 60 is rotated for adjusting the width of the slit, the threaded part of the adjusting bolt 61 is moved forward into the second guide groove 42b along the transverse direction of the slit 21. Then, the combining projection 34 in the second guide groove 42b is moved forward toward the transverse direction of the slit 21 because when the adjusting bolt 61 moves forward, it pushes the combining projection 34 forward. Accordingly, the movable tray member 33 formed with the combining projection 34 is moved slightly forward, so that the width of the slit 21 between the stationary and movable tray members 31 and 33 can be adjusted.

One end of the mixing bag contained inside of the oven compartment 10 is wound by the upper kneading drum 11. Then, the other end of the mixing bag passes through the pair of dough-blocking members 13 and the slit 21 formed at the bottom of the baking tray 30 and then the mixing bag is wound by the lower kneading drum 12. The mixing bag filled with the raw materials for bread is reciprocated up and down by the upper and lower kneading drums 11 and 12 during a kneading process, so that the raw materials for bread are kneaded between the pair of dough-blocking members 13 and the baking tray 30. After completing the kneading process, the mixing bag is released from the upper kneading drum 11 because only the lower kneading drum 12 is rotated. Then, the mixing bag passes through the pair of dough-blocking members 13 and finally the slit 21 formed at the bottom of the baking tray 30. When the mixing bag passes through the slit 21 of the baking tray 30, the kneaded dough contained in the mixing bag cannot pass the slit 21 of the baking tray 30, therefore, the kneaded dough is separated from the mixing bag and contained in the baking tray 30. However, the mixing bag can pass through the slit 21 of the baking tray 30 and is wound by the lower kneading drum 12. Thereafter, the kneaded dough contained in the baking tray 30 is baked by the baking heater 16.

In the bread maker of the present invention, the width of the slit 21 can be adjusted by the adjusting bolt 61, which make the raw materials contained in the mixing bag uniformly kneaded between the pair of dough-blocking members 13 and the baking tray 30.

When the width of the slit 21 is broader or narrower than the predetermined width which should be kept during the kneading process, the width of the slit 21 can be adjusted by rotating each of the adjusting bolts 61 combined with the pair of tray holder members 40.

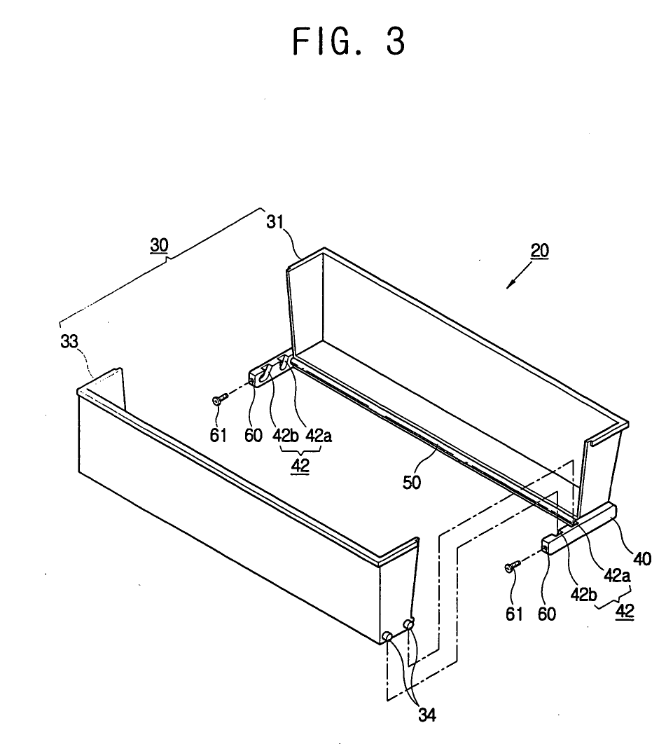

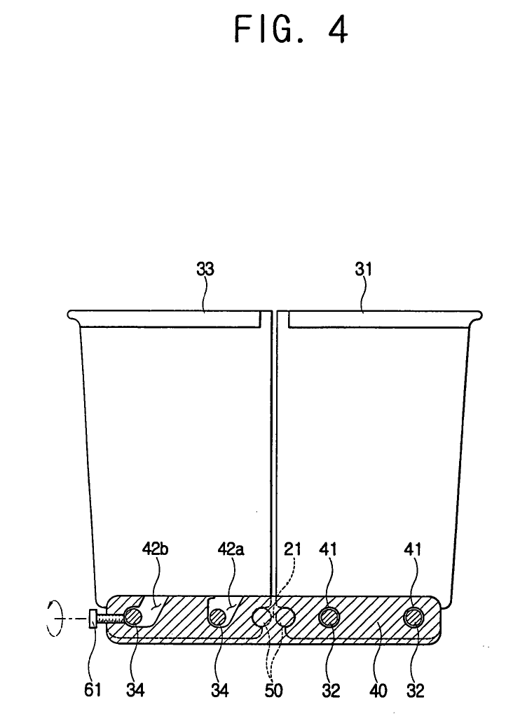

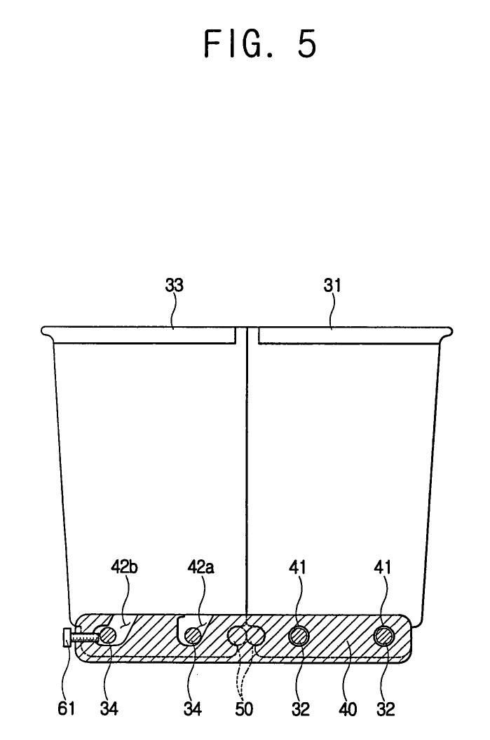

As shown in FIGS. 3-5, the bread maker further comprises an adjusting means having a screw hole 60 and an adjusting bolt 61. When the adjusting bolt 61 screw-engaged with the screw hole 60 is rotated for adjusting the width of the slit 21, the threaded part of the adjusting bolt 61 is moved forward into the second guide groove 42b along the transverse direction of the slit 21. Then, also the combining projection 34 in the second guide groove 42b is moved forward toward the transverse direction of the slit 21 because when the adjusting bolt 61 moves forward, it pushes the combining projection 34 forward. Accordingly, the movable tray member 33 formed with the combining projection 34 is moved slightly forward, so that the width of the slit 21 between the stationary and movable tray members 31 and 33 becomes narrower. In contrast, when the adjusting bolt 61 is rotated in the reverse direction, the adjusting bolt 61 contacted with the combining projection 34 in the second guide groove 42b is moved backward. Thus, the movable tray member 33 is moved backward apart from the stationary tray member 31, so that the width of the slit becomes broader. The width of the slit 21 may be adjusted so as to keep the width of the slit 21 constant, which is required for the uniform kneading of the dough in the mixing bag.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A bread maker comprising:
a main body forming an oven compartment;
an upper kneading drum and a lower kneading drum which are spaced apart from each other in an upper part and a lower part of the oven compartment and hold opposite ends of a mixing bag, respectively;
a baking tray having a stationary tray member and a movable tray member which are disposed between the upper and lower kneading drums facing each other and forming a slit to pass the mixing bag through, wherein the movable tray member is formed with a plurality of combining projections on opposite sidewalls thereof; and
a pair of tray holder members which supports the stationary tray member and is formed with a plurality of guide grooves to accommodate the plurality of combining projections for movably supporting the movable tray member, being combined with opposite ends of the pair of tray holder members;
wherein a screw hole communicated with the plurality of guide grooves is formed at one end of each of the tray holder members and an adjusting member moving the movable tray member is connected with the screw hole.

2. The bread maker of claim 1, wherein each of the tray holder members is formed with a first guide groove and a second guide groove and the screw hole is communicated with the second guide groove toward the transverse direction of the slit.

3. The bread maker of claim 2, further comprising:
a pair of dough profile parts facing each other in the slit and contacting with the mixing bag.

4. The bread maker of claim 1, wherein the adjusting member is an adjusting bolt screw-engaged with the screw hole.

5. The bread maker of claim 2, wherein the adjusting member is an adjusting bolt screw-engaged with the screw hole.

6. The bread maker of claim 3, wherein the adjusting member is an adjusting bolt screw-engaged with the screw hole.

7. The bread maker of claim 1, wherein the stationary tray member and the movable tray member are L-shaped sections symmetrical to each other.

8. The bread maker of claim 2, wherein each of the tray holder members are slidingly combined with a plurality of guide members which are mounted on the inner side walls of the oven compartment.

9. The bread maker of claim 1, wherein the stationary tray member comprises:
a plurality of stationary projections projected from a lower surface of the opposite sidewalls of the stationary tray member and the plurality of stationary projections are securely combined with the pair of tray holder members.

10. The bread maker of claim 9, wherein the plurality of stationary projections are inserted into a plurality of stationary projections accommodating parts of the pair of tray holder members.
